(19) United States
(12) Patent Application Publication
(10) Pub. No.: US 2020/0278854 A1
(43) Pub. Date: Sep. 3, 2020

(54) INFORMATION PROCESSING APPARATUS AND INFORMATION PROCESSING SYSTEM

(71) Applicant: FUJITSU CLIENT COMPUTING LIMITED, Kanagawa (JP)

(72) Inventor: Tomohito Okubo, Kawasaki (JP)

(73) Assignee: FUJITSU CLIENT COMPUTING LIMITED, Kanagawa (JP)

(21) Appl. No.: 16/750,529

(22) Filed: Jan. 23, 2020

(30) Foreign Application Priority Data
Feb. 28, 2019 (JP) 2019-035880

(51) Int. Cl. G06F 8/65; G06F 13/16

(52) U.S. Cl. CPC G06F 8/65; G06F 13/1668

(57) ABSTRACT

An information processing apparatus is connected to a plurality of computers over a bus system. The information processing apparatus includes a memory and a hardware processor coupled to the memory. The hardware processor: receives an input of package software including updaters that are data for individually updating configuration elements of each of the plurality of computers; acquires configuration information representing configuration elements of a computer to be updated out of the plurality of computers; transfers, over the bus system to the computer to be updated, one of the updaters in the package software that is specified by the acquired configuration information; and performs an update of the computer to be updated by carrying out the transfer of the specified updater.

### CROSS-REFERENCE TO RELATED APPLICATIONS

This application is based upon and claims the benefit of priority from Japanese Patent Application No. 2019-035880, filed Feb. 28, 2019, the entire contents of which are incorporated herein by reference.

### FIELD

Embodiments described herein relate to an information processing apparatus and an information processing system.

### BACKGROUND

Conventionally, a distributed computer including a plurality of processors has been known. The distributed computer aims at processing at higher speed by distributing processing among processors. The distributed computer may include processors with different computer architectures.

When updating software in such a distributed computer, it is necessary to prepare, for each type of computer architecture, an updater to be used for updating and perform the update on each processor.

However, a complicated work has been required to implement operation management for each type of computer architecture.

### SUMMARY

An information processing apparatus according to an embodiment of the present disclosure is connected to a plurality of computers over a bus system. The information processing apparatus includes a memory and a hardware processor couple to the memory. The hardware processor is configured to: receive an input of package software including updaters that are data for individually updating configuration elements of each of the plurality of computers; acquire configuration information representing configuration elements of a computer to be updated out of the plurality of computers; transfer, over the bus system to the computer to be updated, one of the updaters in the package software that is specified by the acquired configuration information; and perform an update of the computer to be updated by carrying out the transfer of the specified updater.

### BRIEF DESCRIPTION OF THE DRAWINGS

FIG. 1 is a block diagram illustrating an example of a configuration of an update system according to an embodiment;

FIG. 2 is a diagram illustrating an example of an entire configuration of a distributed computer according to the embodiment;

FIG. 3 is a block diagram illustrating an example of a hardware configuration of each node according to the embodiment;

FIG. 4 is a diagram illustrating an example of a data configuration of configuration list information according to the embodiment;

FIG. 5 is a block diagram illustrating an example of a functional configuration of the nodes according to the embodiment;

FIG. 6 is a flowchart illustrating an example of determination processing performed by a management node according to the embodiment;

FIG. 7 is a flowchart illustrating an example of transfer processing performed by the management node according to the embodiment; and

FIG. 8 is a flowchart illustrating an example of update processing performed by a managed node according to the embodiment.

### DETAILED DESCRIPTION

The information processing apparatus and the information processing system according to the present disclosure exert the effects of facilitating update of software that is compliant with computer architecture of a processor.

The following describes with detail an embodiment of the information processing apparatus and the information processing system according to the invention.

### First Embodiment

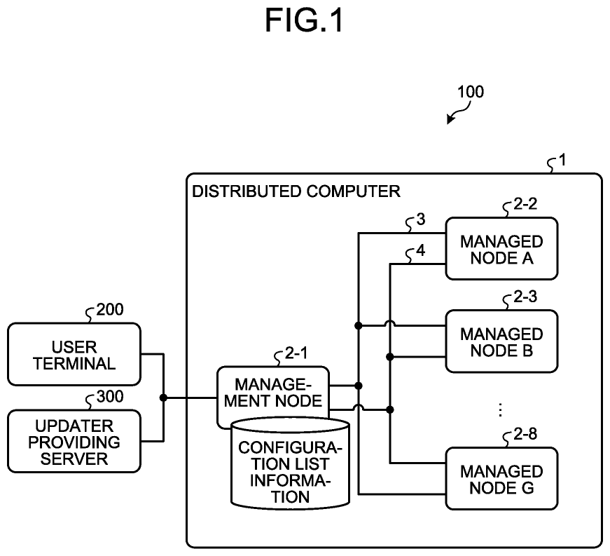

FIG. 1 is a block diagram illustrating an example of a configuration of an update system 100 according to the embodiment. The update system 100 illustrated in FIG. 1 is a system for individually updating software of managed nodes 2-2 to 2-8 of a distributed computer 1 in accordance with individual computer architectures of those managed nodes 2-2 to 2-8.

The distributed computer 1 is an information processing system in which a management node 2-1 and the managed nodes 2-2 to 2-8 are connected over a bus system.

The management node 2-1 is an information processing apparatus that is connected to the managed nodes 2-2 to 2-8 over the bus system. The management node 2-1 is connected to the managed nodes 2-2 to 2-8 over two or more buses of the bus system. The management node 2-1 requests the managed nodes 2-2 to 2-8 to perform various kinds of processing when an execution request for various kinds of processing is received from a user terminal 200 or the like. The managed nodes 2-2 to 2-8 are computers each performing various kinds of processing in accordance with an execution request from the management node 2-1.

The management node 2-1 is communicably connected to the managed nodes 2-2 over a first bus 3 that is formed by a virtual local area network (LAN) using a peripheral component interconnect express (PCIe), for example. Furthermore, the management node 2-1 is communicably connected to the managed nodes 2-2 to 2-8 over a second bus 4 that is formed by a console connection having a recommended standard-232C (RS-232C) interface or the like. The first embodiment describes a case in which the distributed computer 1 includes seven managed nodes 2-2 to 2-8. However, the number of managed nodes 2-2 to 2-8 is not limited to seven as long as it is two or more. Moreover, the first bus 3 is not limited to a virtual LAN using PCIe, and may be formed by another kind of communication such as a universal serial bus (USB).

The update system 100 includes the distributed computer 1, the user terminal 200, and an updater providing server 300.

The user terminal 200 is a terminal that receives operation of a user of the distributed computer 1. The user terminal 200 may be a personal computer or the like.

The updater providing server 300 is a server device that provides package software to be used for updating the distributed computer 1. The updater providing server 300 may be a personal computer or the like.

The package software includes updaters that are data for individually updating configuration elements of each of the managed nodes 2-2 to 2-8. The package software may include an update program that causes the managed node to carry out the update thereof.

In the distributed computer 1 of such an update system 100, the management node 2-1 receives package software from the updater providing server 300 when updating the managed nodes 2-2 to 2-8. The management node 2-1 specifies (or selects) an updater from the package software based on computer architecture of one of the managed node 2-2 to 2-8 to be updated. Then, the management node 2-1 transmits the specified updater to the managed node to be updated, thereby performing the update. When the communication with the managed node to be updated is not possible, the management node 2-1 changes a communication path to proceed with the update.

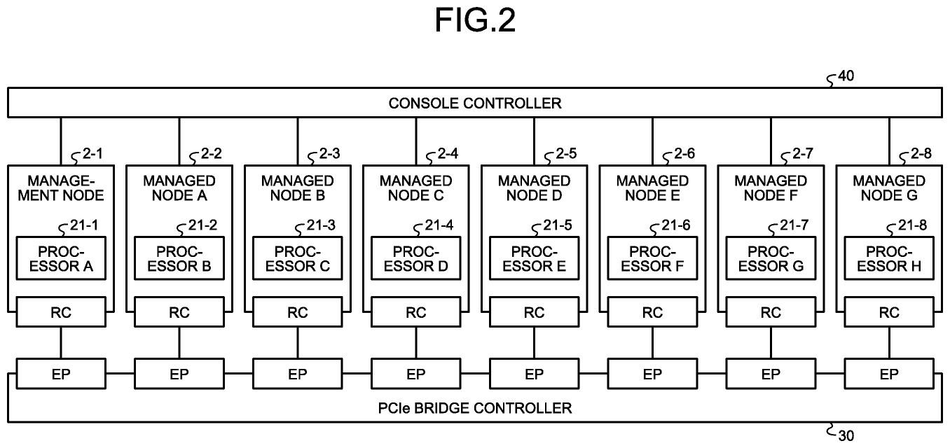

FIG. 2 is a diagram illustrating an example of an entire configuration of the distributed computer 1 according to the embodiment. As illustrated in FIG. 2, the distributed computer 1 of the embodiment includes the management node 2-1, the managed nodes 2-2 to 2-8, a PCIe bridge controller 30, and a console controller 40.

The management node 2-1 is communicably connected to the managed nodes 2-2 to 2-8 over the PCIe bridge controller 30. The management node 2-1 and the managed nodes 2-2 to 2-8 may be, for example, inserted in slots on a board where the PCIe bridge controller 30 is provided. In this case, any of the slots may be empty without a node inserted therein. Moreover, the management node 2-1 is communicably connected to the managed nodes 2-2 to 2-8 over the console controller 40. In the following description, when an arbitrary node is indicated without distinction among the management node 2-1 and the managed nodes 2-2 to 2-8, it will be described as a node 2 or nodes 2.

The management node 2-1 manages the managed nodes 2-2 to 2-8 and controls the managed nodes 2-2 to 2-8 to perform various kinds of processing. The management node 2-1 also manages update of individual software of the managed nodes 2-2 to 2-8.

Each of the managed nodes 2-2 to 2-8 performs, for example, artificial intelligence (AI) inference processing, image processing, and the like, in accordance with a request from the management node 2-1. Each of the managed nodes 2-2 to 2-8 carries out the update of software in accordance with a request from the management node 2-1.

The nodes 2 are provided with processors 21-1 to 21-8 (hardware processors). The processors 21-1 to 21-8 have mutually different computer architectures. Note that the processors 21-1 to 21-8 may be provided by mutually different manufactures or by the same manufacture. In the following description, when an arbitrary processor is indicated without distinction among the processors 21-1 to 21-8, it will be described as a processor 21 or processors 21.

While the processor 21 serves as a root complex (RC) that operates at a host side, a device provided in the PCIe bridge controller 30 serves as an end point (EP). Then, data transfer is performed between the host (RC) and the device (EP).

Moreover, the PCIe bridge controller 30 controls the first bus 3 provided inside and performs data transfer between EPs. That is, the PCIe bridge controller 30 implements communication between the nodes 2.

The node 2 is also connected to the console controller 40. The console controller 40 controls the second bus 4 to implement data transfer between the nodes 2.

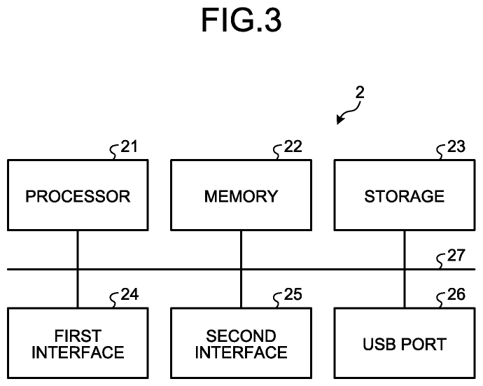

FIG. 3 is a block diagram illustrating an example of a hardware configuration of each node 2 according to the embodiment.

The node 2 includes the processor 21 (a hardware processor) performing various kinds of arithmetic processing, a memory 22 temporarily storing various kinds of information, a storage 23 storing various kinds of information, a first interface 24, a second interface 25, and an USB port 26. Each of them is connected to a bus 27.

The processor 21 controls the node 2. The processor 21 may be a multiprocessor. The processor 21 may be any one of a central processing unit (CPU), a micro processing unit (MPU), a graphics processing unit (GPU), a digital signal processor (DSP), an application specific integrated circuit (ASIC), a programmable logic device (PLD), and a field programmable gate array (FPGA). Moreover, the processor 21 may be a combination of two or more elements among CPU, MPU, GPU, DSP, ASIC, PLD, and FPGA.

The memory 22 is a storage memory including a read only memory (ROM) and a random access memory (RAM). Various software programs and data for the software programs are written in the ROM of the memory 22. The software program on the memory 22 is read out by the processor 21 and executed. The RAM of the memory 22 is used as a primary storage memory or a working memory.

The storage 23 is a storage device such as a hard disk drive (HDD), a solid state drive (SSD), and a storage class memory (SCM), and stores various kinds of data. Various software programs are stored in the storage 23. The storage 23 also stores various kinds of data such as configuration list information.

In the node 2, various functions are implemented by that the processor 21 executes software programs stored in the memory 22 and the storage 23.

Note that the above-described software programs are not necessarily stored in the memory 22 or the storage 23. For example, the node 2 may read out software programs stored in a storage medium readable by the node 2 and execute them. The storage medium readable by the node 2 includes, for example, a portable storage medium such as a CD-ROM, a DVD disk, and a universal serial bus (USB) memory, a semiconductor memory such as a flash memory, a hard disk drive, and the like. Moreover, devices connected to a public network, the Internet, LAN, and the like may store the information processing program, so that the node 2 reads out the information processing program from them and executes it.

The first interface 24 is an interface for connecting to the first bus 3.

The second interface 25 is an interface for connecting to the second bus 4.

The USB port 26 is a USB interface.

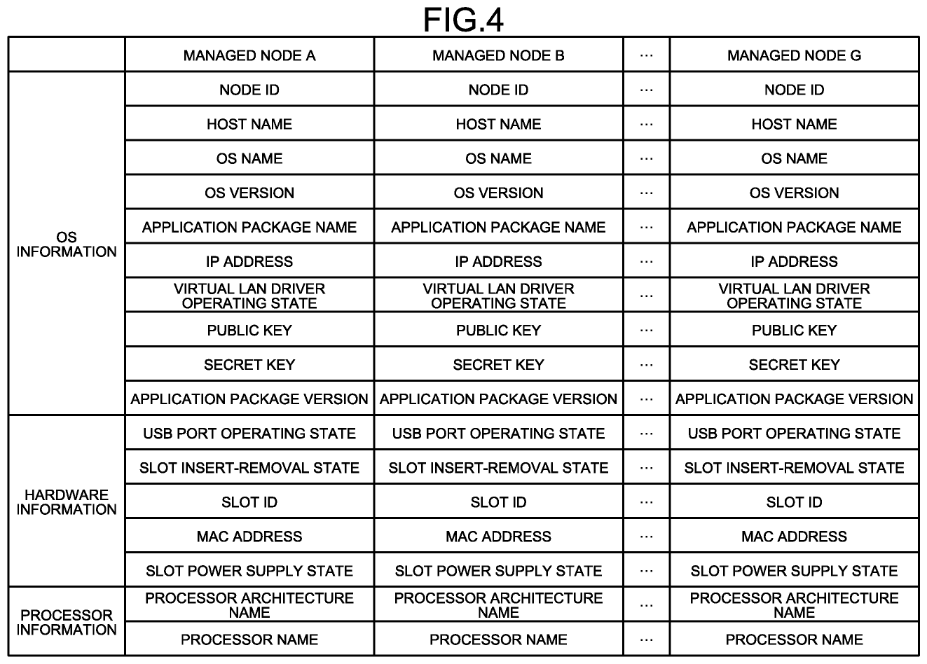

FIG. 4 is a diagram illustrating an example of a data configuration of configuration list information according to the embodiment. The configuration list information includes configuration information representing configuration elements of each of the managed nodes 2-2 to 2-8. The configuration information includes an operation system (OS) information, hardware information, and processor information.

The OS information is information related to the OS of the managed nodes 2-2 to 2-8. The OS information includes, for example, a node ID, a host name, an OS name, an OS version, an application package name, an internet protocol (IP) address, a virtual LAN driver operating state, a public key, a secret key, and an application package version. Note that the OS information may not include all information mentioned above. The OS information may include information other than the above-mentioned information.

The hardware information is information related to hardware of the managed nodes 2-2 to 2-8. The hardware information includes, for example, a USB port operating state, a slot insert-removal state, a slot ID, a media access control (MAC) address, and a slot power supply state. Note that the hardware information may not include all information mentioned above. Moreover, the hardware information may include information other than the above-mentioned information.

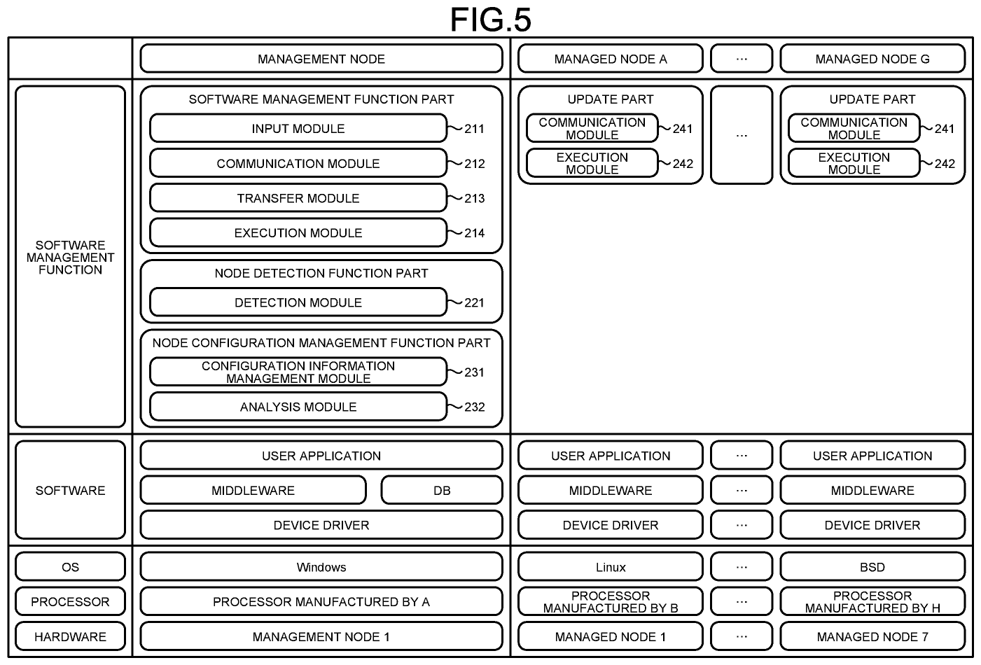

The processor information is information related to the processor 21 of the managed nodes 2-2 to 2-8. The processor information includes a processor architecture name and a processor name. Note that the processor information may not include all information mentioned above. Moreover, the processor information may include information other than the above-mentioned information. FIG. 5 is a block diagram illustrating an example of a functional configuration of the nodes 2-1 to 2-8 according to the embodiment. FIG. 5 illustrates individual configurations of the management node 2-1 and the managed nodes 2-2 to 2-8. Regarding the hardware, the management node 2-1 and the managed nodes 2-2 to 2-8 have mutually different hardware. Regarding the processor 21, the management node 2-1 and the managed nodes 2-2 to 2-8 include the processor 21 provided by mutually different manufactures. That is, the management node 2-1 and the managed nodes 2-2 to 2-8 include the processor 21 having mutually different computer architectures. Alternatively, part of the nodes 2 may each include the processor 21 having common computer architecture. For example, the managed node A (2-2) and the managed node B (2-3) may include the processor 21 having common computer architecture.

Moreover, regarding the OS, an OS is installed in each of the management node 2-1 and the managed nodes 2-2 to 2-8. For example, Windows (registered trademark) is installed in the management node 2-1. Linux (registered trademark) is installed in the managed node A2-2. Berkeley software distribution (BSD) is installed in the managed node G2-8. Note that the OSs illustrated in FIG. 5 are examples, and may be changed to any OS.

Moreover, regarding the software, user application, middleware, data base (DB), and a device driver are installed in the management node 2-1. Moreover, user application, middleware, and a device driver are installed in the managed nodes 2-2 to 2-8.

The management node 2-1 has a software management function, a node configuration management function, and a node detection function.

A software management function part includes an input module 211, a communication module 212, a transfer module 213, and an execution module 214.

The input module 211 is an example of the input module in Claims. The input module 211 receives an input of package software including an updater that are data for individually updating configuration elements of each of the managed nodes 2-2 to 2-8. To be more specific, the input module 211 receives package software from the updater providing server 300. Note that the input module 211 may receive package software from a device other than the updater providing server 300. Moreover, the input module 211 may receive an input of package software by reading it out from a storage medium.

The communication module 212 detects a communication path and the managed nodes 2-2 to 2-8. Then, the communication module 212 controls communication with the detected managed nodes 2-2 to 2-8. To be more specific, the communication module 212 detects a first communication path. The first communication path is a communication path for directly communicating, over the first bus 3, with the managed node to be updated.

When the first communication path is not detected, the communication module 212 detects a second communication path. The second communication path is a communication path for communicating, over the first bus 3, with the managed node to be updated via other managed nodes.

Moreover, when the second communication module is not detected, the communication module 212 detects a third communication path. The third communication path is a communication path for communicating, over the second bus 4, with the managed node to be updated.

The transfer module 213 is an example of the transfer module in Claims. The transfer module 213 transfers an updater and update programs to the managed nodes to be updated over the first bus 3 or the second bus 4. To be more specific, the transfer module 213 authenticates the managed nodes 2-2 to 2-8 and transmits the updater and the update programs after encrypting them. The transfer module 213 authenticates the managed nodes 2-2 to 2-8 by, for example, the secure sockets layer (SSL) certificate method or an authentication method using an ID or a password. The transfer module 213 encrypts the updater and the update programs by using a protocol such as an SSH file transfer protocol (SFTP) or a secure copy protocol (SCP).

The execution module 214 is an example of the execution module in Claims. The execution module 214 controls the transfer module 213 to transfer the updater specified by configuration information acquired by a detection module 221 (described later) to the managed nodes 2-2 to 2-8 over the first bus 3 or the second bus 4, thereby performing the update of the managed nodes 2-2 to 2-8. To be more specific, the execution module 214 controls the transfer module 213 to transfer the updater and the update programs over a communication path on the first bus 3 or the second bus 4, which has been determined by the communication module 212.

For example, when the communication module 212 determines to use the second communication path because it is impossible to transfer the updater and the like over the first communication, the execution module 214 controls the transfer module 213 to carry out transfer using the second communication path. That is, in the case where an updater cannot be directly transferred over the first bus 3 to the managed node to be updated (for instance, the managed node 2-2), the execution module 214 causes the updater to be transferred over the first bus 3 to the managed node to be updated (2-2) via one or more managed nodes (any of the managed nodes 2-3 to 2-8) other than the managed node (2-2) to be updated.

For another example, when the communication module 212 determines to use the third communication path because it is impossible to transfer the updater and the like over the first communication path and the second communication path, the execution module 214 controls the transfer module 213 to carry out using the second bus 4. That is, in the case where an updater cannot be transferred over the first bus 3, the execution module 214 causes the updater to be transferred over the second bus 4 to perform the update.

Note that the update program includes a preprocessing program, an installation program, a post processing program, and a rollback program. The preprocessing program is a computer program executed prior to the update. For example, the preprocessing is a computer program for executing processing of saving snapshots for obtaining the states of the managed nodes 2-2 to 2-8 and data stored in the managed nodes 2-2 to 2-8. The installation program is a computer program for updating the managed nodes 2-2 to 2-8 using an updater. The post processing program is a computer program executed after the update. For example, the post processing program is a computer program for deleting unnecessary data and performing verification processing of verifying whether the update has been performed normally. In the verification processing, data communication is performed with other managed nodes 2-2 to 2-8 to verify whether the update has been performed normally. The verification processing is not limited thereto, and another method may be adopted to verify whether the update has been performed normally. The rollback program is a computer program for performing rollback to restore the state before the update when it is determined by the post processing program that the update has failed.

Moreover, when the update of each managed node is performed, the execution module 214 determines whether all the managed nodes to be updated have failed in updating. Here, the distributed computer 1 includes a plurality of managed nodes 2-2 to 2-8. Then, the distributed computer 1 may control the managed nodes 2-2 to 2-8 to collaborate so that they can act as one function. In such a case, the managed nodes 2-2 to 2-8 have a dependent relation with one another to collaboratively output a single result of processing.

With the dependent relation, when part of the managed nodes 2-2 to 2-8 to be updated fails in updating, a difference occurs in functions of the managed nodes 2-2 to 2-8. In this case, the managed nodes 2-2 to 2-8 are not able to collaboratively perform processing with one another.

In view of the above inconvenience, when part of the managed node fails in updating, the execution module 214 restores the part of the managed nodes to the state before the update. Furthermore, the execution module 214 restores, to the state before the update, also the managed node(s) having succeeded in updating.

On the other hand, when there is no dependent relation among the managed nodes 2-2 to 2-8, no problem occurs even if a difference occurs in functions of the managed nodes 2-2 to 2-8. Thus, when part of the managed nodes 2-2 to 2-8 to be updated have failed in updating, the execution module 214 may determine whether to restore to the state before the update on the basis of the dependent relation between the managed node having failed in updating and other managed nodes. Then, depending on a result of the determination, the execution module 214 performs rollback for restoring the managed nodes 2-2 to 2-8 to the state before the update.

The node detection function part includes the detection module 221.

The detection module 221 is an example of the acquisition module in Claims. The detection module 221 acquires configuration information representing configuration elements of each of the managed nodes 2-2 to 2-8. To be more specific, the detection module 221 detects the managed nodes 2-2 to 2-8 on a communication path. The detection module 221 confirms, by using a determined communication path, whether the managed nodes 2-2 to 2-8 are activated, whether the power is supplied, and the like. For example, in order to determine the operating states of the managed nodes 2-2 to 2-8, the detection module 221 performs confirmation of communication with all the managed nodes 2-2 to 2-8 based on a list of MAC addresses and thereby confirms whether the managed nodes 2-2 to 2-8 exist.

Then, the detection module 221 acquires OS information, hardware information, or processor information from the detected managed nodes (2-2 to 2-8). That is, the detection module 221 acquires configuration information about the managed node(s) to be updated. Then, when the OS information, the hardware information, or the processor information is acquired, the detection module 221 gives the acquired information to a configuration information management module 231.

The node configuration management function part includes the configuration information management module 231 and an analysis module 232.

The configuration information management module 231 manages configuration information representing the configurations of the managed nodes 2-2 to 2-8. To be more specific, when the configuration information is acquired from the managed nodes 2-2 to 2-8, the configuration information management module 231 stores the acquired information in the configuration list information (FIG. 4) according to the individual managed nodes 2-2 to 2-8.

The analysis module 232 compares the configuration information acquired by the detection module 221 with the configuration information included in the package software and thereby specifies an updater that is compliant with the configuration element of the managed node to be updated. The analysis module 232 may specify such compliant updater not only when the configuration information acquired by the detection module 221 totally matches the configuration information in the package software but also when they are different partially. For example, the analysis module 232 may specify an updater corresponding to the managed node to be updated when a processor name described in the acquired configuration information is a formal name, whereas the one described in the configuration information in the package software is a partially omitted name.

Moreover, regarding the software management function, each of the managed nodes 2-2 to 2-8 includes an update part. The update part includes a communication module 241 and an execution module 242.

The communication module 241 is an example of the reception module in Claims. The communication module 241 receives an updater and update programs from the management node 2-1 over the first bus 3 or the second bus 4. Moreover, the communication module 241 transmits, to the management node 2-1, an execution result indicating whether or not the update has succeeded.

The execution module 242 carries out the update. To be more specific, the execution module 242 carries out the update on the basis of the updater and the update program received by the communication module 241. Furthermore, the execution module 242 verifies whether the update has succeeded.

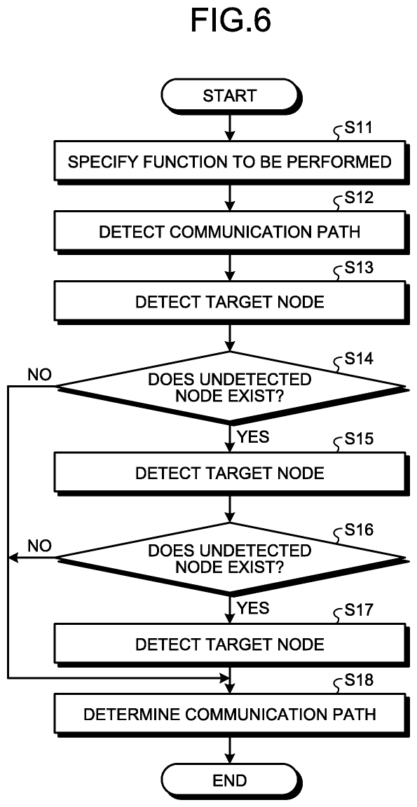

Next, the determination processing will be described. In the following, the determination processing is performed to determine communication paths over which the management node 2-1 transmits updaters for updating the managed nodes 2-2 to 2-8. FIG. 6 is a flowchart illustrating an example of determination processing performed by the management node 2-1 according to the embodiment.

The execution module 214 receives operation of specifying a function to be performed, that is, operation of instructing the update of the managed nodes 2-2 to 2-8 (Step S11).

Alternatively, that the execution module 214 may receive operation of instructing acquisition of configuration information of the managed nodes 2-2 to 2-8. In the case of the instruction to acquire configuration information, the execution module 214 does not perform the update of the managed nodes 2-2 to 2-8 and outputs the acquired configuration information.

The communication module 212 detects one or more communicable communication paths (Step S12). In the present embodiment, the communication module 212 detects the first communication path, the second communication path, and the third communication path described above.

Subsequently, the detection module 221 detects, out of the managed nodes 2-2 to 2-8, the managed node as a target node that is communicable over the first communication path (Step S13).

The detection module 221 determines whether there is an undetected managed node among the managed nodes 2-2 to 2-8 to be updated (Step S14). When no undetected managed node exists (No at Step S14), the management node 2-1 shifts the processing to Step S18.

When the undetected managed node exists (Yes at Step S14), the detection module 221 detects the managed node as a target node that is communicable over the second communication path (Step S15).

The detection module 221 determines whether there is an undetected managed node among the managed nodes 2-2 to 2-8 to be updated (Step S16). When no undetected managed node exists (No at Step S16), the management node 2-1 shifts the processing to Step S18.

When the undetected managed node exists (Yes at Step S16), the detection module 221 detects the managed node as a target node that is communicable over the third communication path (Step S17).

The communication module 212 determines to transmit each of the updaters over one of the communication paths on which the corresponding managed node to be updated has been detected (Step S18).

Then, the management node 2-1 terminates the processing of determining a communication path.

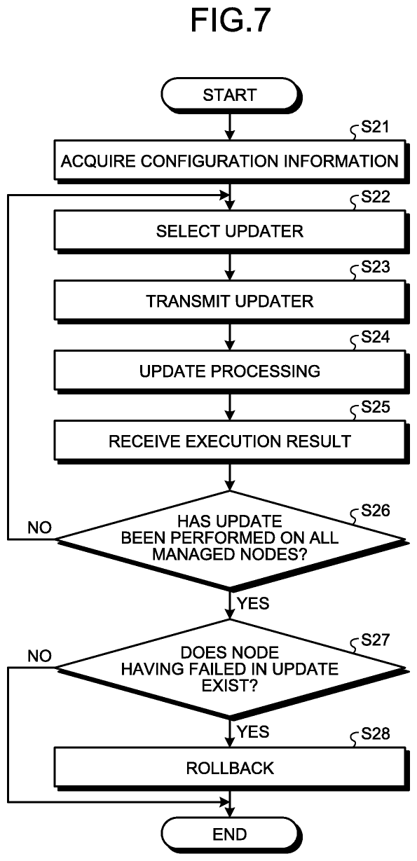

Next, the transfer processing of transferring an updater by the management node 2-1 will be described. FIG. 7 is a flowchart illustrating an example of the transfer processing performed by the management node 2-1 according to the embodiment.

The detection module 221 acquires configuration information from each of the managed nodes 2-2 to 2-8 (Step S21). That is, the detection module 221 acquires OS information, hardware information, and processor information about each of the managed nodes 2-2 to 2-8.

The analysis module 232 specifies (or selects), for each managed node, an updater compliant with the configuration element of the corresponding managed node on the basis of the configuration information acquired from the corresponding managed node and the configuration information included in the package software, which represents the configuration element to which the updater is to be applied (Step S22).

The transfer module 213 controls the communication module 212 to transmit the specified updaters and update programs to the managed node 2-2 to 2-8 (Step S23).

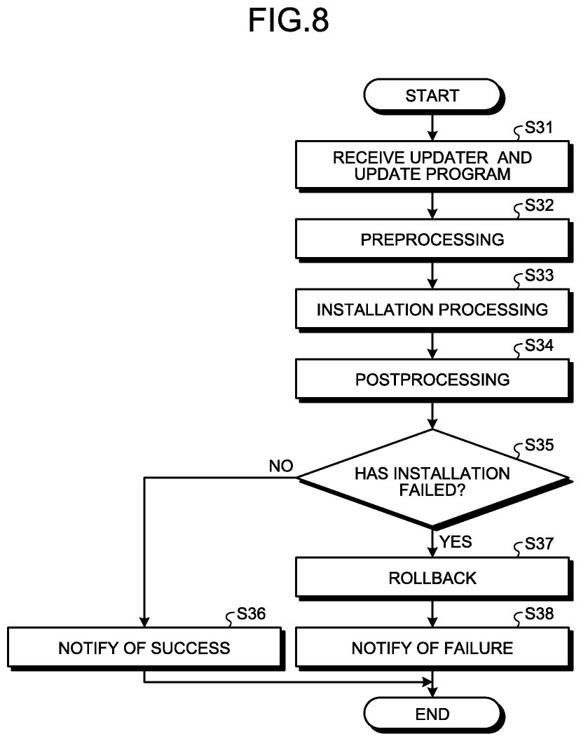

The management node 2-1 waits for the managed nodes 2-2 to 2-8 to carry out the update processing using the updaters and the update programs (Step S24). The update processing will be described in detail with reference to FIG. 8.

After that, the communication module 212 of the management node 2-1 receives results of the update processing from the managed nodes 2-2 to 2-8 (Step S25).

The execution module 214 determines whether the update processing has been performed on all the managed nodes 2-2 to 2-8 to be updated (Step S26). When there is an unperformed managed node on which the update processing has not yet been performed (No at Step S26), the management node 2-1 shifts the processing to Step S22 and causes the unperformed managed node to perform the update processing.

When the update processing has been performed on all the managed nodes 2-2 to 2-8 (Yes at Step S26), the execution module 214 determines, based on the execution results from the managed nodes 2-2 to 2-8, whether there is a failed managed node that have failed in updating (Step S27).

When no failed managed nodes exist (No at Step S27), the management node 2-1 terminates the transfer processing.

On the other hand, when the failed managed node exist (Yes at Step S27), the execution module 214 performs rollback (Step S28). Specifically, the execution module 214 restores, by rollback, the failed managed node to the state before the update. Alternatively, the execution module 214 may determine whether to restore to the state before the update on the basis of the dependent relation among the managed nodes 2-2 to 2-8. In this case, the execution module 214 restores to the state before the update on the basis of a determination result. For example, when the managed nodes 2-2 to 2-8 have the dependent relation with one another, all of them (2-2 to 2-8) are restored to the state before the update.

In this manner, the management node 2-1 completes the transfer processing. In the above-described transfer processing, the management node 2-1 sequentially performs the update of the managed nodes 2-2 to 2-8. Alternatively, the management node 2-1 may perform the update of the managed nodes 2-2 to 2-8 with parallel processing by transmitting updaters and update programs in a time division manner.

The following describes the update processing in which each of the managed nodes 2-2 to 2-8 carries out updating by using an updater based on an update program. FIG. 8 is a flowchart illustrating an example of the update processing performed by each of the managed nodes 2-2 to 2-8 according to the embodiment.

The communication module 241 receives an updater and an update program (Step S31).

The execution module 242 performs preprocessing in accordance with the update program (Step S32).

The execution module 242 performs installation processing of performing the update using the updater in accordance with the update program (Step S33).

The execution module 242 performs post processing in accordance with the update program (Step S34).

The execution module 242 determines whether the installation has failed (Step S35). When the installation has succeeded (No at Step S35), the communication module 241 transmits, to the management node 2-1, an execution result representing that the update has succeeded (Step S36).

When the installation has failed (Yes at Step S36), the execution module 242 performs rollback for restoring to the state before the installation (Step S37). Then, the communication module 241 transmits, to the management node 2-1, an execution result indicating that the update has failed (Step S38).

In this manner, each of the managed nodes 2-2 to 2-8 completes the update processing.

As described above, in the embodiment, the management node 2-1 acquires configuration information representing configuration elements of each of the managed nodes 2-2 to 2-8. The management node 2-1 receives, when updating the managed nodes 2-2 to 2-8, an input of package software including updaters that individually update the configuration elements of the managed nodes 2-2 to 2-8 to be updated, the configuration elements being included in configuration information of the package software. The management node 2-1 specifies, for each managed node, an updater from among one or more updaters included in the package software on the basis of the configuration information acquired from the managed nodes 2-2 to 2-8. Then, the management node 2-1 transfers the specified updater to the corresponding one of the managed nodes 2-2 to 2-8 to perform the update. In this manner, without performing operation management for each processor architecture, the management node 2-1 is able to perform the update with an updater that is compliant with the processor architecture of each individual managed node (2-2 to 2-8). Therefore, the management node 2-1 is able to facilitate update of software that is compliant with the computer architecture of the processor 21.

Furthermore, the management node 2-1 according to the first embodiment is connected to the managed nodes 2-2 to 2-8 over the bus system including the first bus 3 and the second bus 4. When the transfer of an updater is not possible over the first bus 3, the execution module 214 of the management node 2-1 causes the updater to be transferred over the second bus 4 to perform the update. In this manner, the management node 2-1 is able to perform the update of each of the managed nodes 2-2 to 2-8 even when the first bus 3 is not communicable.

When it is impossible to directly transfer over the first bus 3 an updater to the managed node to be updated (for instance, the managed node 2-2), the execution module 214 of the management node 2-1 transfers over the first bus 3 the updater to the managed node (2-2) to be updated via one or more managed nodes (any of the managed nodes 2-3 to 2-8) other than the managed node to be updated. In this manner, the management node 2-1 is able to perform the update of the managed node even when it is not possible to perform direct communication with the managed node to be updated.

When the managed nodes 2-2 to 2-8 to be updated have failed in updating, the execution module 214 of the management node 2-1 restores the managed nodes 2-2 to 2-8 to the state before the update. Thus, even when the update of the managed nodes 2-2 to 2-8 has failed, the management node 2-1 is able to prevent the case in which the cooperation processing by the managed nodes 2-2 to 2-8 is disabled.

When part of the managed nodes 2-2 to 2-8 to be updated has failed in updating, the execution module 214 of the management node 2-1 restores the managed nodes 2-2 to 2-8 to the state before the update, on the basis of the dependent relation between the managed node having failed in updating and other managed nodes. Thus, the management node 2-1 is able to reduce a range subjected to rollback for restoring to the state before the update.

In the distributed computer 1 of the embodiment, the management node 2-1 and the managed nodes 2-2 to 2-8 are connected over the bus system. The management node 2-1 includes the input module 211, the detection module 221, and the execution module 214. The input module 211 receives an input of package software including updaters that are data for individually updating configuration elements of each of the managed nodes 2-2 to 2-8. The execution module 214 controls the transfer module 213 to transfer the updaters, each being specified by the configuration information acquired by the detection module 221, to the managed nodes 2-2 to 2-8 over the first bus 3 or the second bus 4, thereby performing the update of the managed nodes 2-2 to 2-8. Each of the managed nodes 2-2 to 2-8 is provided with the communication module 241 for receiving an updater over the bus system. Thus, without performing operation management for each processor architecture, the distributed computer 1 is able to perform update using updaters that are individually compliant with the processor architectures of the managed nodes 2-2 to 2-8. Therefore, the distributed computer 1 is able to facilitate the update of software compliant with the computer architecture of the processor 21.

In the above-described embodiment, the PCIe is exemplified as a bus (e.g., an expansion bus) or an I/O interface. The bus or the I/O interface is not limited to the PCIe. For example, the bus or the I/O interface is only required to adopt the technology of transferring data between the device (a peripheral controller) and the processor over a data transfer bus. The data transfer bus may be a general bus that allows transferring data at a high speed in a local environment provided in a single housing (e.g., a single system or a single device). The I/O interface may be either a parallel interface or a serial interface.

In the case of the serial transfer, the I/O interface may be configured to allow performing point-to-point connection and packet-based transfer of data. Note that, in the case of serial transfer, the I/O interface may include a plurality of lanes. The layer structure of the I/O interface may include a transaction layer for generating packets and performing decoding, a data link layer for detecting errors and the like, and a physical layer for performing conversion between serial and parallel. Moreover, the I/O interface may include a route complex that is the uppermost in the layer structure having one or more ports, an end point that is an 110 device, a switch for increasing ports, a bridge for converting protocols, and the like. The I/O interface may multiplex data and clock signals to be transmitted by a multiplexer and transmit them. In this case, the reception side may separate data and clock signals by a demultiplexer.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus connected to a plurality of computers over a bus system, the information processing apparatus comprising:
a memory; and
a hardware processor coupled to the memory, wherein the hardware processor:
receives an input of package software including updaters that are data for individually updating configuration elements of each of the plurality of computers;
acquires configuration information that represent configuration elements of a computer to be updated out of the plurality of computers;
transfers, over the bus system to the computer to be updated, one of the updaters in the package software that is specified by the acquired configuration information; and
performs an update of the computer to be updated by carrying out the transfer of the specified updater.

2. The information processing apparatus according to claim 1, wherein
the bus system includes a first bus and a second bus, and,
when the specified updater fails to be transferred over the first bus, the hardware processor further performs the update by carrying out the transfer of the specified updater to the computer to be updated over the second bus.

3. The information processing apparatus according to claim 1, wherein, when the specified updater fails to be directly transferred to the computer to be updated, the hardware processor further performs the update by carrying out the transfer of the specified updater to the computer to be updated via one or more of the plurality of computers other than the computer to be updated.

4. The information processing apparatus according to claim 1, wherein, when the update of the computer to be updated fails, the hardware processor further restores the computer to a state before the update.

5. The information processing apparatus according to claim 4, wherein, when part of the plurality of computers to be updated fails in the update, the hardware processor further restores the part of the plurality of computers to a state before the update based on a dependent relation between the failed computer and other computers.

6. An information processing system comprising:
an information processing apparatus; and
a plurality of computers connected to the information processing apparatus over a bus system, wherein
the information processing apparatus includes:
a memory; and
a hardware processor coupled to the memory, wherein the hardware processor:
receives an input of package software including updaters that are data for individually updating configuration elements of each of the plurality of computers;
acquires configuration information representing configuration elements of a computer to be updated out of the plurality of computers;
transfers, over the bus system to the computer to be updated, one of the updaters in the package software that is specified by the acquired configuration information; and
performs an update of the computer to be updated by carrying out the transfer of the specified updater, and
each of the plurality of computers includes:
a memory; and
a hardware processor coupled to the memory, wherein the hardware processor receives the updater over the bus system.
